(19) United States
(12) Patent Application Publication
(10) Pub. No.: US 2025/0392986 A1
(43) Pub. Date: Dec. 25, 2025

(54) INTELLIGENT INSTALLER APPLICATION FOR ENERGY MANAGEMENT SYSTEMS

(71) Applicant: Budderfly, Inc., Shelton, CT (US)

(72) Inventors: Jacob Marchinus Boerma, Orange, CT (US); Fernando Olado Perez Acuna, Tampa, FL (US); Aias Martakis, Woodside, NY (US)

(21) Appl. No.: 19/246,439

(22) Filed: Jun. 23, 2025

Related U.S. Application Data
(60) Provisional application No. 63/663,309, filed on Jun. 24, 2024.

(51) Int. Cl. H04W 52/02; H04W 12/06; H04W 88/18

(52) U.S. Cl. CPC H04W 52/0209; H04W 12/06; H04W 88/18

(57) ABSTRACT

A system for managing and sharing credentials for network access in a secure manner for energy management equipment whereby the installer is granted access automatically through secure credentials exchange with a cloud-based server. The technician does not have to enter and does not have visibility to said credentials throughout the process adding an element of security to the granting of temporary access to systems for repairs or maintenance. Further elements built into the network devices as to how they advertise their presence over Bluetooth and disable this function once configured are also presented.

### FIELD OF THE INVENTION

The present disclosure relates to systems and methods for the secure installation and commissioning of energy equipment on customer premises where internet access through a local router is required.

### BACKGROUND

The desire to reduce energy consumption is widespread and there are a growing number of smart devices that can be installed at a site and configured or accessed wirelessly.

The devices themselves are growing increasingly smart offering a growing number of parameters to monitor consumption and savings data as well as configure settings for devices such as thermostats, sensors, refrigeration units, HVAC (heating ventilation and air conditioning) units, to name just a few.

Devices typically connect through one or more Wi-Fi routers or other forms of wireless connections that are installed on the premises. The access to the network(s) is/are managed through the local router and changes can be made on-site or through the cloud. The devices themselves typically offer a local interface through a broadcast Wi-Fi network or Bluetooth for on-site configuration.

Support personnel that aid in the installation, maintenance and configuration of these devices require connection information to the local Wi-Fi to perform their tasks of installing and configuring the local devices so that they may communicate with a back-end system.

Installation of such equipment is often done through a network of installers, sometimes they may be contractors. It is undesirable for the facilities to share sensitive network access information with a potentially large group of individuals, and it is unpractical for the facilities to change passwords and reconfigure systems after each maintenance event.

When an installer arrives on site with the goal of installing new energy saving equipment at a QSR (quick serve restaurant), secure access information such as SSID (service set identifier) and password to the local Wi-Fi network is required in order to access the devices and configure connection information to get them talking to the back-end systems. Often the Wi-Fi network provided to connect the various equipment to (refrigerators, ovens, HVAC etc.) is a separate network where it is not desired to have other devices connected. The people that are on site may not know the password or may not have it handy. It may be desirable to restrict access to the local Wi-Fi for managing the building systems out of concern that it may be used for personal use or that sharing the password may create security vulnerabilities. The installer may have to track down the appropriate person or otherwise find the correct Wi-Fi information, which may cause delays or require a second service call once the information can be located.

Even if arriving with the password, it's possible that the password was changed as this can only be validated on site. Worse yet, the new password may have been forgotten or the person that changed it may no longer work there. Such cases may lead to the installers having to return a second time or invoke a lengthy process of tracking down the right individuals to gain access. It may even involve resetting devices to factory defaults and performing reconfiguration. This all adds time and cost to the installation, and the possibility of introducing errors in configuration.

In other cases, a router may have been replaced and the new settings not logged properly, or perhaps even left to a default setting which is easily guessed. Other blatant security holes are also commonplace such as leaving a yellow sticky note with access codes and passwords to circumvent the above issues. Even if done with good intentions, granting unauthorized access to the network may result in increased bandwidth fees, or worse, exploitation of the network for malicious purposes. These may lead to added surprise costs for the facility and even the risk of liability for such activities.

It would be beneficial if access to the local network and the devices at hand could be controlled remotely and not require manual intervention thereby reducing the risk of unauthorized access. It would be further beneficial if access could be provided in a role-based and time-based need-to-know fashion, so that those visiting a particular site would gain access to only the devices that they were scheduled to service, and for that access to disappear after the work was complete or at a predetermined period following the service. It would further be beneficial if the devices themselves would limit the functionality available through the local interfaces to prevent unauthorized reconfiguration or network access.

US Publication No. 2022/0116778 to Laudermilch relates to systems and methods for preventing unauthorized access to a network resource on a network by a mobile device, particularly a system for determining whether a mobile device is authorized to access a network resource and granting/denying access to the network resource based on determining this authorization. However, this disclosure does not discuss providing credentials to that device nor removing/deleting those credentials or ways to manage those credentials among several locations and devices.

U.S. Pat. No. 10,356,618 to Conant describes systems for securing credential distribution which authenticates a request for network credentials and provides those credentials to the wireless device. However, this disclosure does not mention or relate to connecting other devices to the network and distributing those credentials to those local devices nor does this system relate to removing/deleting the credentials from the requesting device.

Therefore, it would be highly desirable to have a system that can provide access to credentials for one or more local Wi-Fi network to the installers that are performing scheduled and authorized upgrades, installations, or maintenance at sites that lets them connect seamlessly to the local system to gain access to the network credentials needed as part of their installation process.

It would be further desirable to have the system access limited in scope and duration based on the employee role and work schedule, allowing the credentials management system to enable and disable access to users based on their work schedules and the sites on their daily work orders.

It would be still further desirable if such a credentials management system could remain up to date with changes to the local router configurations and could provide updates to the central system of any local configuration changes or equipment changes.

It would be still further beneficial if any of these Wi-Fi credentials changes could be propagated to the devices via an alternate interface to reestablish communications.

Finally, it would be beneficial for the devices themselves to limit local access and reconfiguration activities and to limit these to the setup of remote access only through this alternate interface, being a local Bluetooth port, a LoRaWAN connection, or other alternate interface made available during such time when connectivity is lost.

### SUMMARY OF THE INVENTION

The present system allows for network access information to be managed and securely provided to the devices without the need for any manual configuration to access the local network. Information is sent in a manner that the installer does not know or see the password and access is granted and credentials shared only to the appropriate installers. Thus, the system provides access to a local Wi-Fi network credentials at a customer site to those technicians scheduled to be at a given site with sufficient rights to access the equipment and to do the tasks that they are scheduled to perform.

Therefore, one object of the invention is a system that can provide access to credentials for one or more local Wi-Fi network to the installers that are performing scheduled and authorized upgrades, installations, or maintenance at sites that lets them connect seamlessly to the local system to gain access to the network credentials needed as part of their installation process.

Another object of the invention is to provide access limited in scope and duration based on the employee role and work schedule, allowing the credentials management system to enable and disable access to users based on their work schedules and the sites on their daily work orders.

Another object of the invention is to provide a credentials management system which can remain up to date with changes to the local router configurations and could provide updates to the central system of any local configuration changes or equipment changes.

Another object of the invention is to provide a system which allows Wi-Fi credentials changes to be propagated to the devices via an alternate interface to reestablish communications.

Yet another object of the invention is to provide for the devices themselves to limit local access and reconfiguration activities and to limit these to the setup of remote access only through this alternate interface, being a local Bluetooth port, a LoRaWAN connection, or other alternate interface made available during such time when connectivity is lost.

In one configuration, a credentials management system is provided that hosts Wi-Fi access point SSID information and password information organized by site. In such a configuration, the access information to the sites networks is maintained and updated on a server in the cloud and stored in a secure encrypted fashion. An installation application running on a mobile device is used to gather this access information where it is retained temporarily during the installation process.

The foregoing and other objects are achieved by providing a control device comprising a controller comprising with a processor having software executing thereon. The controller is configured to control a device which uses energy and the controller is configured to provide first and second network connections. The controller is configured to activate or deactivate the first network connection based on whether the second network connection is connected or not connected to a network such that when the second network connection is not connected to the network, the first network connection is activated automatically and when the second network connection is connected to the network, the first network connection is deactivated and automatically reactivated if the second network later becomes disconnected from the network.

In certain aspects the first network connection is a Bluetooth connection. In other aspects the first and second network connections utilize different communications protocols. In yet other aspects the first and second network connections utilize different frequency bands. In still other aspects the second network connection is a Wi-Fi connection.

The foregoing and further objects are achieved by providing a method of connecting local devices to a network connection including one or more steps of: obtaining authentication information via a first network connection at a first computer from a mobile application which verifies user permission to access a second network; verifying said authentication information; and determining credentials for said second network and returning said credentials to the mobile application via the first network connection for providing said credentials to at least one local device for connection the at least one local device to said second network.

In certain aspects the method includes identifying at least one local device via a connection to the second network at the first computer and providing instructions to the mobile application to remove the credentials. In other aspects the method includes transmitting the credentials from the mobile application to the at least one local device via a third network connection between the mobile application and the at least one local device. In still other aspects the method includes providing instructions to the mobile application to remove the credentials. In still further aspects the credentials are removed based on a location of the mobile device. In yet further aspects the credentials are removed based on a time period. In still further aspects the time period is associated with an amount of time that the mobile device is connected to the third network. In yet other aspects the third network is Bluetooth connection.

The foregoing and further objects are achieved by providing a method of connecting local devices to a network connection comprising one or more steps of: authenticating a login at a mobile application executing on a mobile device and transmitting authentication via a first network connection to a first computer from the mobile application; verifying said authentication information; receiving credentials for said second network and at the mobile application via the first network connection; and identifying at least one local device via a connection to a third network and providing the credentials to the at least one local device.

In certain aspects the method includes receiving a request to remove the credentials and removing the credentials from the mobile device. In certain aspects the third network uses a Bluetooth connection. In other aspects, by providing the credentials to the at least one local device, the at least one local device is able to connect to the second network. In still other aspects the second network is an internet connection. In still other aspects the credentials are deleted from the mobile device based on a time period or based on a location of the mobile device or a combination thereof.

The foregoing and further objects are achieved by providing: a method of connecting local devices to a network connection comprising one or more of the steps of: obtaining authentication information at a first computer from a plurality of mobile devices, each mobile device at a different location, the authentication information verifies user permission for each of the mobile devices to access a network local to that mobile device; verifying said authentication information; determining credentials for the network local to each mobile device associated with verified authentication information and returning said credentials to the mobile device associated with that corresponding network local to that mobile device; and identifying at least one local device for one or more of the networks and providing the credentials associated with the corresponding network to the at least one local device.

In some aspects the method includes removing the credentials from the mobile device and in some aspects the credentials are removed based on a location of the mobile device and/or based a time period.

While the focus in the descriptions and the examples used herein relate to routers, local energy management devices, Bluetooth, LoRaWAN, and Wi-Fi networks within restaurants, similar mechanisms to communicate credentials for systems access or network access could be created for other applications which would benefit from a similar system.

Other aspects and features of the invention will become apparent from consideration of the following description taken in conjunction with the accompanying drawings.

### BRIEF DESCRIPTION OF THE DRAWINGS

FIG. 1 Depicts a system overview.

FIG. 2A Depicts the components-overview of the system and

FIG. 2B depicts an example process flow of the system.

FIG. 3 Depicts a similar components-overview of a larger system made up of multiple networks and a larger installation.

FIG. 4 Depicts a Technician Installer App Receiving Credentials for a site.

FIG. 5. Depicts a device power up sequence from a factory reset or during initial installation.

### DETAILED DESCRIPTION

Referring now to the drawings, wherein like reference numerals designate corresponding structure throughout the views. The following examples are presented to further illustrate and explain the present invention and should not be taken as limiting in any regard.

Example embodiments as described herein provide the components for securely sharing the credentials for access to local networks by installers and configuring on site devices to connect to such a network.

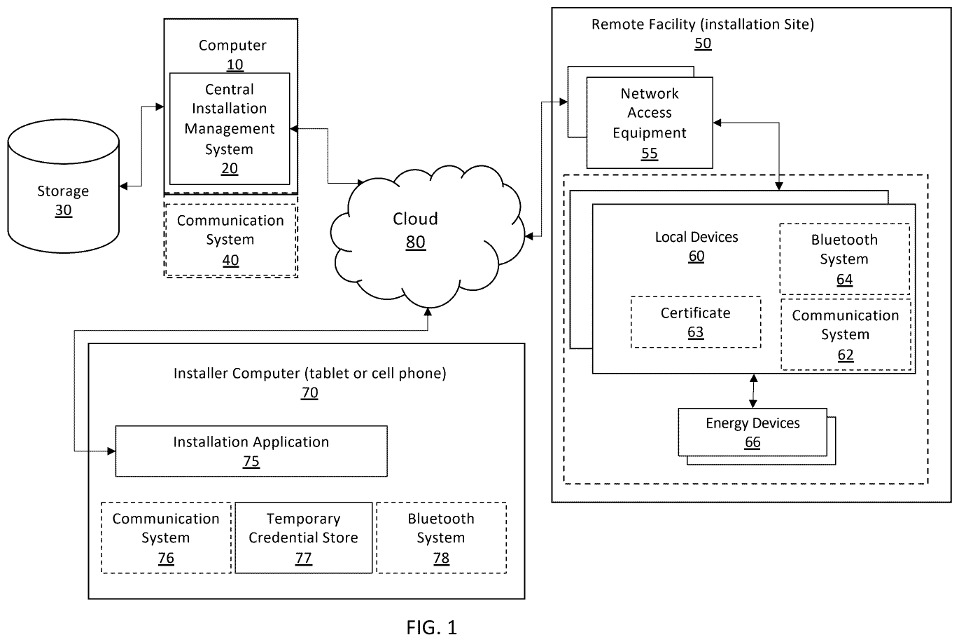

Turning to the drawings, FIG. 1 shows a basic systems overview. A computer 10 is runs the central installation management system 20. It is connected to a storage 30 system which in turn will be shown to house securely encrypted credentials as well as job scheduling and technician information. The computer 10 also has a communication system 40 which connects it to the internet cloud 80.

A remote facility 50 with network access equipment 55 provides internet access to one or more local devices 60, this network access equipment 55 provides, for example, the Wi-Fi network 140 that these local devices 60 need to connect to using the necessary credentials which are supplied via the installer application. These local devices may be, for example, refrigeration units, thermostats, remotely controlled lighting, ovens, heating and a variety of other Wi-Fi_33 enabled devices which can be controlled, particularly in kitchens and restaurants.

Local devices 60 having certificates 63 to establish unique connection details that can be authenticated also have a Bluetooth communication system 64 and a Wi-Fi communication system 62. In some cases there may also be alternate interfaces such as LoRaWAN when longer range is required, or a local means to reestablish communications without the need for an installer application being present is supplied, thus the network access equipment 55 may not be limited to Wi-Fi_33 only.

Finally, an installer computer or tablet 70 runs an installation application 75 and is equipped with a temporary credentials store 77. A communication system 76 allows the installation app 75 to connect to the cloud 80 and communicate with the central management system 20. A Bluetooth wireless system 78 also allows local communications with local devices 60 that also have Bluetooth systems 64.

If passwords are changed locally on devices such as routers, or if equipment is replaced with a different configuration, these changes are updated in the back-end system through the use of webhooks or callback functions in the router software allowing the back-end installation management system to stay up to date. The new information is stored in the secure credentials store, and available to the installer app for subsequent setup and installation to the site when appropriate, for example based on a scheduled job and time and/or location.

When the Wi-Fi password or SSID is changed, through a factory defaults reset or some other error condition or manual means, local devices which had been connected to the backend lose their connectivity. Once they lose the connectivity, they again begin to broadcast over Bluetooth or an alternate interface allowing a local device to update the credentials. In cases of lost connectivity due to network outages, the devices will concurrently retry connecting while broadcasting over this alternate network. Should connectivity be reestablished, the Bluetooth or alternate network broadcasting will cease. Importantly in some embodiments, the switching to broadcast via Bluetooth to allow configuration of the Wi-Fi_33 network is done automatically in the event of a loss of connection as some of the devices themselves may be inaccessible or in hard to reach locations or behind walls or otherwise such that the need to press a button or otherwise physically interact with the device itself to turn on Bluetooth connectivity is impractical.

In cases of authorized changes, the technician is likely already present, and able to reload the data from the backend and reload it to the devices over Bluetooth. When the technician is not present, alternative means can be employed at the site such as having the facilities controller or another LoRaWAN enabled device to propagate the new credentials. The fallback position is to have an installer with the installer app return to the site to connect to the devices over Bluetooth in order to propagate the changed credentials.

A back-end installation management system also maintains a list of technicians with their roles and access rights. The back-end system uses work schedules and employee role-based authentication to validate and share credentials ensuring that these are only shared with the appropriate installers for the sites they are visiting as part of their route and job function. Such role-based access can determine which types of equipment they have access to and in what capacity. For example, who can change configurations, who can install new devices, who can adjust which settings.

In another configuration, a job scheduling application is integrated with the back-end system that contains information about the sites that are to be visited by the technicians in a given timeframe. The combination of which technician will be on which site on what day and at what time provides a level of security to managing the credential distribution for access to the local networks.

In another configuration, a mobile application is provided to the technicians that runs on a local computer, tablet, or smartphone (or other local device used for configuration) which communicates with a central cloud based management system, or back-end system and is able to retrieve the access information including the Wi-Fi SSID and passwords for one or more routers at the site. The appropriate network information for the specific site is downloaded as required by the onsite technician using the installer application on their mobile device where the credentials are temporarily stored in a secure temporary store sight-unseen by the installer.

In such a configuration, the mobile application also has a Bluetooth function which is capable of communicating with the local devices in order to configure them with the backend supplied connection information and access point information as required for the connection. Devices come out of the factory with a connection string or pre-determined connection URL, defining where they should connect to send their data. What is unique and must be configured at each site is the network connectivity information. Once they have this connection information, they can send their monitoring data and receive control instructions from the central system. This mode should continue and does not need the intervention of the installer app or a technician and is the normal state.

The installer application, when the job is completed or if a predetermined period has passed, will remove the local credentials from the local temporary secure storage of the installer mobile device running the installation application preventing further access to the local system. The back-end system in the cloud must extend the timeframe or reschedule the technician in order to extend the connection window.

Throughout the process, the technician does not see the credentials. His installation application is connected to cellular, and communicating with the back-end. Once on site, the back end is able to provide the connection data to the app over cellular. xxx

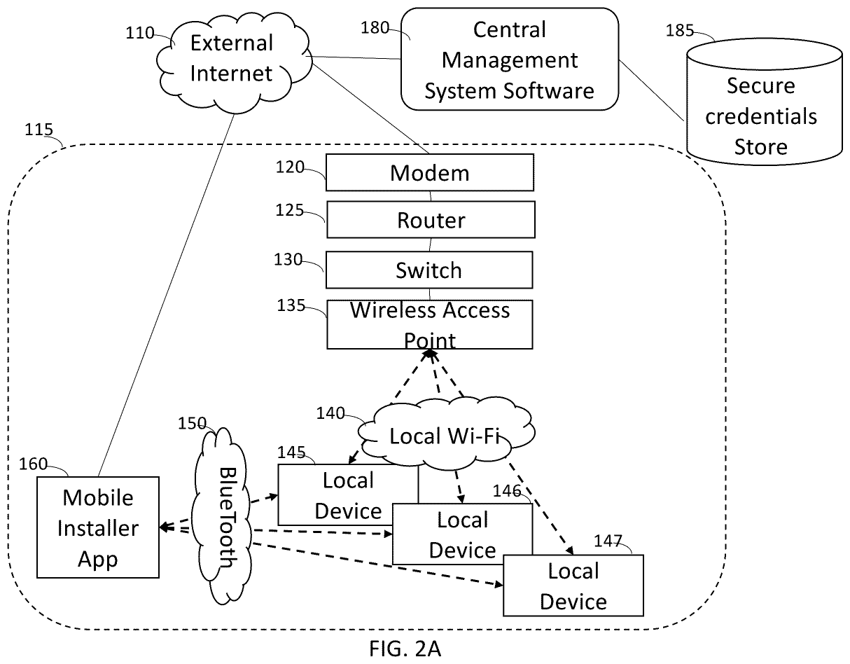

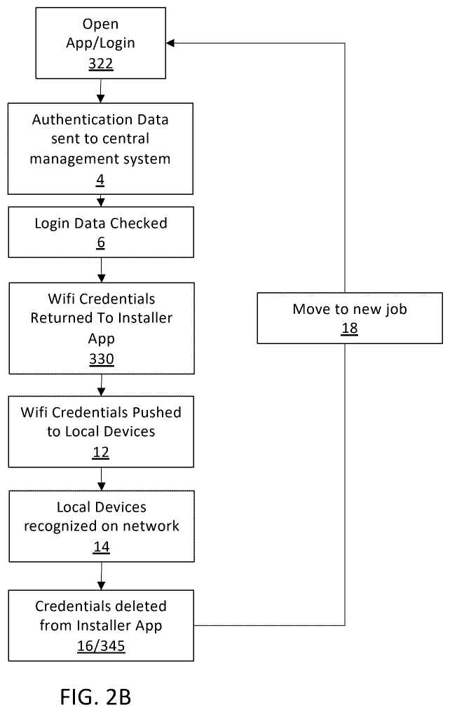

FIG. 2A is a high-level components overview of the system. A modem 120 is connected to the external internet 80. Also connected to the internet is the central management system 20 which is connected to the secure credentials store 30. Also connected to the internet is the mobile installer app 75.

On the local premises 115, a modem 120, router 125, switch 130, and a wireless access point 135 provide connectivity to the external internet 80. One or more of these devices may be combined in a single device depending on the configuration and the number of devices. In the illustrated figure, local devices 60, 136, and 147 are connected to the local Wi-Fi network 140 supplied by the wireless access point 140. Local devices 60, 146, and 147 also may broadcast information over Bluetooth 150.

A mobile installer app 75 is depicted as being on premises 115 and in proximity of the local devices 60 so as to be able to connect over Bluetooth 150 to the devices.

The Mobile Installer App 75 is used to configure the Wireless Access Point 135 credentials in the devices over Bluetooth 150 connections provided by the Bluetooth systems 46/78 of the installer device and the local devices so that they can connect through the local Wi-Fi 140 and access the central management system 20 through the external internet 80. Once connected, control and monitoring equipment is exchanged from the central management system 20 and the devices 60, 146, 147.

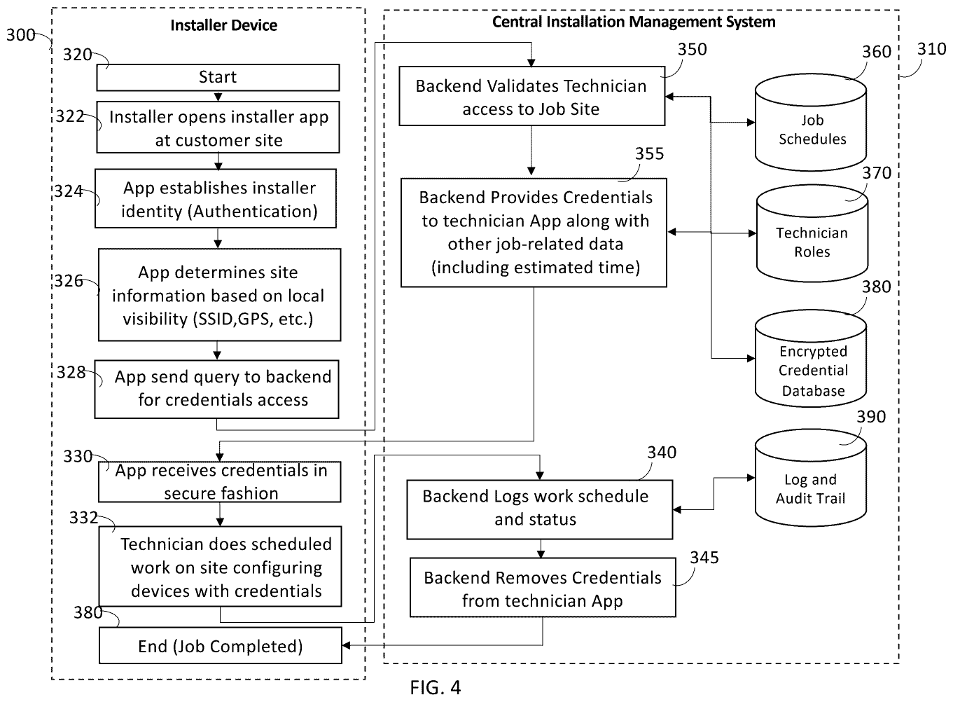

Referring to FIG. 2B and 4 Accordingly, the installer will open and login 322 to the mobile installer app (which is usually on a phone or tablet) and that mobile installer app will communicate over an internet connection with the central management system 20. This communication can include login data sent to the central management system 4 such as certificate(s) or other authenticating information to verify the device. Thus, the installer's identity has been authenticated 324. Furthermore, the mobile installer app can communicate the installer's device's location obtained from GPS or other positioning data 326 associated with the installer's device as part of the login data. Communication with the central management system 20 initially may be via cellular or an external data connection, particularly a data connection separate from the local wi-fi. The central management system software 20 executes on a computer/server/processor 10. This software 20 has access to the credentials store 30. The credentials store in some aspects includes expected location information such that for the central management system software 20 to provide the credentials to the mobile installer app 75, the software 20 may require that the location information must match the expected location of the installation job.

The credentials in the store 30 are added initially when the first job at the new location is scheduled and preferably these credentials are updated periodically.

The credentials for the Wi-Fi associated with the particular job are returned to the installer app 75. The installer app then pushes these credentials to local devices 12. This may involve the installer's device accessing the local network via Wi-Fi with the credentials received, alternately, the devices may have their own temporary Wi-Fi network that the installer app can use. Further, the installer app may use installer device communications hardware other than Wi-Fi/cellular to communicate with the local devices. As an example, this could be Bluetooth or NFC communications hardware or other alternate data transfer over the air system. The local devices then connect to the local Wi-Fi network 140 and the local devices are recognized 14 on that network 140 by the installer app or central management system. Once the local devices are recognized, the Wi-Fi credentials are removed from the installer device. This may involve deleting or removing the connection to the local network 140 or may involve the installer app deleting those credentials, for example, in response to a signal from the central management system software which may be indicative of the local devices having connected successfully. In other aspects, the installer device may delete the credentials once the device is moved away from the known location of the installation job, for example outside a geofence or outside a certain distance from the location. The installer then moves to the next job 18 and repeats the process for the next location, each time a job is finished or there is an indication that the job is finished, the credentials are removed from the mobile device and installer app.

In certain aspects, the central management system also stores inventory information and/or job information which determines which devices need to connect to the local network for completion of the job in question. Thus, when the central management system recognizes those devices as being connected to the network the deletion of the credentials is executed. In certain cases, this recognition of the devices on the local network may be in a manner that the local devices do not communicate directly over the internet with the central management system, but rather communicate through local device management computers which provide the central management system with local device lists and/or connection confirmations.

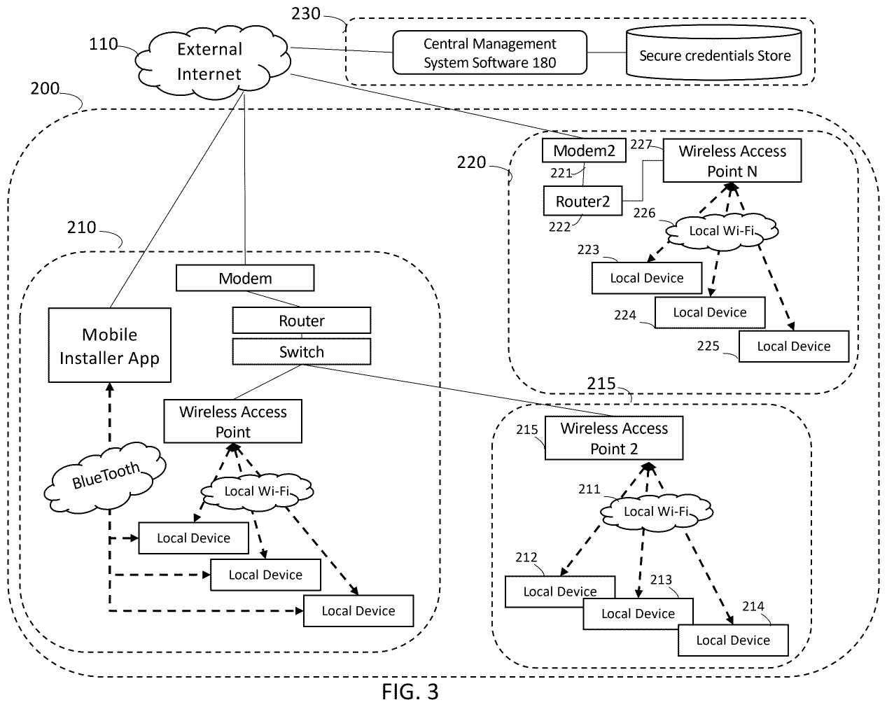

Turning now to FIG. 3, we see a depiction of a larger installation made up of additional components.

On the larger premises 200 we see the same network configuration 115d as described in FIG. 1. Additionally, another network 215 is shown where an additional wireless access point 216 is connected to the switch from the original network 210. Another local Wi-Fi 211 is created by the wireless access point 215 and local devices 212, 213, and 214 and shown connecting to the new Wi-Fi 211 and accessing the external internet 80 through wireless access point 215.

Additionally, a third network 220 is shown whereby a new modem 221 and router 222 are used to connect wireless access point 227 to the internet 80. Again, a local Wi-Fi 226 becomes available for local devices 223, 224, and 225 to connect to the external internet 80. All of the three networks are on the same premises 200 and are needed to provide coverage for a deployment that spans more devices over a larger area or where signals of a single Wi-Fi network would not suffice. In such a configuration the mobile installer app must be brought within proximity of the various local devices in order to receive Bluetooth signals from them and to allow for configuration. Once the devices have been set up with the credentials from the secure credentials store 30 of the central system computer 10, communications are established between the devices and the central management system.

Turning now to FIG. 4 we see a logic flow diagram of a technician installer app receiving the credentials for a particular site. The installer device 70 arrives at a client site and starts 320. The installer opens the app 322 and the app establishes the installer identity 324 through a login to the app or through other secure means including multi-factor authentication.

The app is able to scan the local network and have localization information to establish the location where the technician is present 326 and planning to do the installation or maintenance. The app then sends a query to the backend system 328 to obtain the credentials for the site. The Central installation management system 310 or back-end system validated the technicians access to the job site 350 by checking job schedules 360, specific roles 370 assigned to the technician. If access is granted, then the encrypted credentials 380 for the site are provided 355 and transmitted to the installer app 330. The technician then 332 can proceed with the scheduled maintenance and/or installation with the credentials on hand.

The backend system 310 logs the work schedule and status 340 in an audit trail 390. Status can be captured by the successful detection of devices connecting to the cloud system now that the credentials have been configured 322 by the technician. When all devices are connected, or when the job is flagged complete, or if a predetermined time interval has elapsed, the backend removed the credentials 345 from the technician's application and the job is complete 380.

The app 70 on the installer device also provides secondary removal logic where when connectivity is lost to the central system, the app will remove the credentials from the temporary store. As part of the job description in the job schedule 360 an estimated time to completion is included and this parameter is passed to the application along with the credentials.

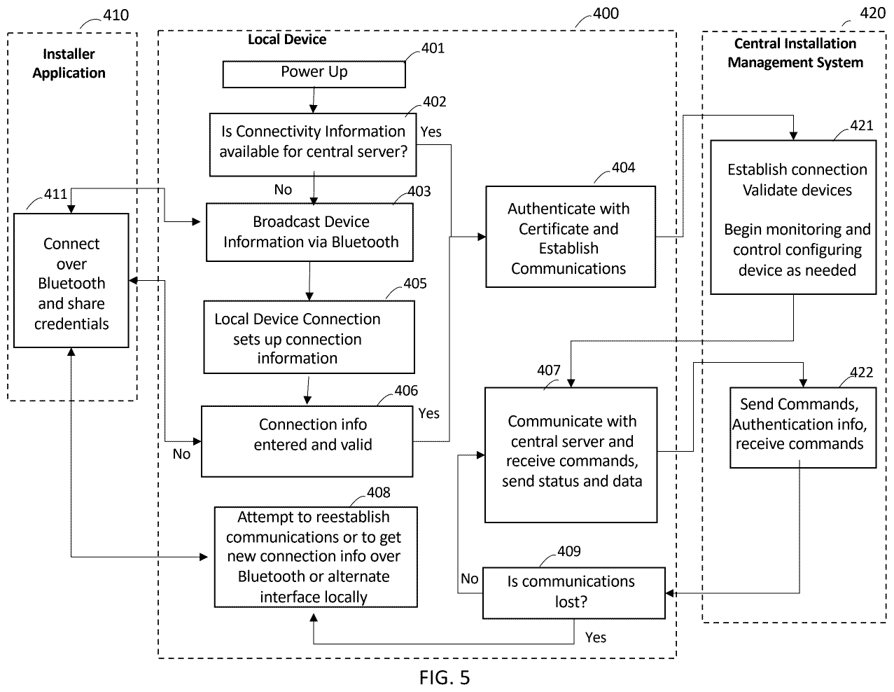

Turning now to FIG. 5, we see a new device 400 power up sequence and configuration with the help of an installer app 75 to connect to the central installation management system 2.

The local device 400 powers up 401 and checks if it has connectivity information 402 to the server. When it is first commissioned at the factory, the device 400 is set with a connection string pointing to the address of the central management system as well as a certificate to validate. However, it doesn't have the information to connect to the local Wi-Fi network to establish communications.

The device 400 broadcasts 403 it's information over Bluetooth and if present an installer app 75 connects 411 with the device and provides credentials that have been obtained from the central installation management system 2 as depicted in FIG. 4. The local device 400 then setups up the connection information 405 and determines if it is valid 406 and if so, it authenticates 404 with its certificate and establishes communications with the central management system 2. At this time the device also stops broadcasting over Bluetooth.

The Central installation management system 2 begins configuration 421 and monitoring of the device according to its needs.

The local device 400 receives commands 407 and as long as communications are working 409 this cycle continues. Should communications drop 409 the device attempts to reestablish 408 communications and failing that will again fall back to broadcasting via Bluetooth to obtain connection information 411 once again repeating the startup cycle until communications is reestablished. Here, the Bluetooth connection turns off 413 automatically when the connection information to the main network (e.g. Wi-Fi) is entered and works. When communications are lost the Bluetooth system is automatically activated 412. Importantly in some embodiments, this automatic activation and de-activation is done without the need for physical interaction with a control on the local control device 400, for example, this automatic activation/deactivation occurs without the need to depress a switch or display a code or interact in the physical proximity with the device or with other objects adjacent to the device, but instead the Bluetooth connection (or other type of connection that allows for obtaining credentials and programming the local control device) automatically activates when connectivity is lost. Although this is described in respect to local device 400 in FIG. 5, it is understood that such features can and often do apply to all the other devices that are being connected using the installer application as described herein.

The devices will also retry connecting even while broadcasting over Bluetooth or alternate interfaces for new connection data. This is for cases where a temporary loss of connectivity may be in progress such as a network outage. Once the connection with the server is reestablished, the Bluetooth or alternate interface broadcasting will cease.

It will be understood by those of skill in the art that while examples using routers, thermostats in restaurant environments, the same system can be adapted and used for any credentials storage and sharing system whether that be network access, systems access, and other systems where secure credentials are used and access to systems for a brief interval such as repair or maintenance must be granted and can be done in a limiting fashion based on role.

While the disclosure is susceptible to various modifications, and alternative forms, specific examples thereof have been shown in the drawings and are herein described in detail. It should be understood however that the disclosure is not limited to the particular forms or methods or embodiments disclosed.

What is claimed:

1. A control device comprising:
a controller comprising a processor with software executing thereon, the controller configured to control a device which uses energy;
said controller configured to provide first and second network connections;
said controller configured to activate or deactivate the first network connection based on whether the second network connection is connected or not connected to a network such that when the second network connection is not connected to the network, the first network connection is activated automatically and when the second network connection is connected to the network, the first network connection is deactivated and automatically reactivated if the second network later becomes disconnected from the network.

2. The device of claim 1 wherein the first network connection is a Bluetooth connection.

3. The device of claim 1 wherein the first and second network connections utilize different communications protocols.

4. The device of claim 1 wherein the first and second network connections utilize different frequency bands.

5. The device of claim 2 wherein the second network connection is a Wi-Fi connection.

6. A method of connecting local devices to a network connection comprising:
obtaining authentication information via a first network connection at a first computer from a mobile application which verifies user permission to access a second network;
verifying said authentication information;
determining credentials for said second network and returning said credentials to the mobile application via the first network connection for providing said credentials to at least one local device for connection the at least one local device to said second network.

7. The method of claim 6 further comprising:
identifying at least one local device via a connection to the second network at the first computer;
providing instructions to the mobile application to remove the credentials.

8. The method of claim 6 further comprising:
transmitting the credentials from the mobile application to the at least one local device via a third network connection between the mobile application and the at least one local device.

9. The method of claim 8 further comprising providing instructions to the mobile application to remove the credentials.

10. The method of claim 8 wherein the credentials are removed based on a location of the mobile device.

11. The method of claim 8 wherein the credentials are removed based on a time period.

12. The method of claim 11 wherein the time period is associated with an amount of time that the mobile device is connected to the third network.

13. The method of claim 12 wherein the third network is bluetooth connection.

14. A method of connecting local devices to a network connection comprising:
authenticating a login at a mobile application executing on a mobile device and transmitting authentication via a first network connection to a first computer from the mobile application;
verifying said authentication information;
receiving credentials for said second network and at the mobile application via the first network connection;
identifying at least one local device via a connection to a third network and providing the credentials to the at least one local device.

15. The method of claim 14 further comprising:
receiving a request to remove the credentials and removing the credentials from the mobile device.

16. The method of claim 14 wherein the third network uses a Bluetooth connection.

17. The method of claim 14 wherein by providing the credentials to the at least one local device, the at least one local device is able to connect to the second network.

18. The method of claim 17 wherein the second network is an internet connection.

19. The method of claim 14 wherein the credentials are deleted from the mobile device based on a time period or based on a location of the mobile device or a combination thereof.

20. A method of connecting local devices to a network connection comprising:
obtaining authentication information at a first computer from a plurality of mobile devices, each mobile device at a different location, the authentication information verifies user permission for each of the mobile devices to access a network local to that mobile device;
verifying said authentication information;
determining credentials for the network local to each mobile device associated with verified authentication information and returning said credentials to the mobile device associated with that corresponding network local to that mobile device;
identifying at least one local device for one or more of the networks and providing the credentials associated with the corresponding network to the at least one local device.

21. The method of claim 17 further comprising:
removing the credentials from the mobile device.

22. The method of claim 21 wherein the credentials are removed based on a location of the mobile device.

23. The method of claim 21 wherein the credentials are removed based on a time period.
